(19) United States
(12) Patent Application Publication
(10) Pub. No.: US 2003/0150947 A1
(43) Pub. Date: Aug. 14, 2003

(54) Fly fishing reel with an unidirectional controller

(76) Inventor: Eugene Hong, Taichung City (TW)

Correspondence Address: MORGAN LEWIS & BOCKIUS LLP, 1111 Pennsylvania Avenue, N. W., Washington, DC, 20004, US

(21) Appl. No.: 10/073,352

(22) Filed: Feb. 13, 2002

(51) Int. Cl. A01K 89/02

(52) U.S. Cl. 242/298; 242/317

(57) ABSTRACT

A fly fishing reel includes a casing, a spool mounted rotatably in the casing, and a unidirectional controller including a ratchet wheel secured to the spool, and a pawl pivoted to the casing and releasably engaging the ratchet wheel. The ratchet wheel includes a plurality of angularly spaced apart first engaging teeth. The pawl includes at least two angularly spaced apart second engaging teeth, which are respectively in sliding contact with two of the first engaging teeth so as to permit rotation of the spool to rotate in a first direction, and which engage the two first engaging teeth so as to prevent rotation of the spool in the second direction opposite to the first direction.

### BACKGROUND OF THE INVENTION

1. Field of the Invention

This invention relates to a fly fishing reel, more particularly to a fly fishing reel with a unidirectional controller that controls the rotation of a spool of the fly fishing reel.

2. Description of the Related Art

FIG. 1 illustrates a conventional drum-type fly fishing reel 100 that includes a casing 1, a spool 2 mounted rotatably in the casing 1 for winding a fishing line (not shown) thereon, and a unidirectional controller 200 associated with the casing 1 and the spool 2 for controlling the rotation of the spool 2 so as to stop unwinding of the fishing line from the spool 2 by a pulling force when a fish is caught. The controller 200 includes a ratchet wheel 3 that is co-axially and securely mounted on one end of the spool 2 so as to be co-rotatable with the latter, and a pawl 4 pivoted to the casing 1 and releasably engaging the ratchet wheel 3. The ratchet wheel 3 includes a plurality of angularly spaced apart 31. engaging teeth, each of which has a sliding face and an engaging face opposite to the sliding face. The pawl 4 has a free end that is formed with a tooth 401 which is in sliding contact with the sliding face of one of the engaging teeth 31 when the ratchet wheel 3 rotates in a first direction, and which engages the engaging face of said one of the engaging teeth 31 when the ratchet wheel 3 is urged to rotate in a second direction opposite to the first direction, thereby preventing rotation of the ratchet wheel 3 and the spool 2 in the second direction. FIG. 2 illustrates another conventional fly fishing reel 300 including a unidirectional controller 400 that is similar to the aforementioned drum-type fly fishing reel 100. The fly fishing reel 300 is different from the aforementioned drum-type fly fishing reel 100 in that a spool 5 is exposed from a casing 6 thereof. The conventional fly fishing reels are disadvantageous in that the tooth 401 of the pawl 4 tends to disengage from the ratchet wheel 3 or break due to relatively high stress present at the tooth 401 when the latter stops rotation of the ratchet wheel 3 and the spool 2 in the second direction upon catching a fish.

### SUMMARY OF THE INVENTION

Therefore, the object of the present invention is to provide a fly fishing reel with a unidirectional controller that is capable of overcoming the aforesaid drawback.

According to the present invention, a fly fishing reel comprises: a casing; a spool mounted rotatably in the casing; and a unidirectional controller associated with the casing and the spool and including a ratchet wheel that is selectively secured to one of the casing and the spool, and a pawl that is pivoted to the other one of the casing and the spool and that releasably engages the ratchet wheel, the ratchet wheel including a plurality of angularly spaced apart first engaging teeth, the pawl including at least two angularly spaced apart second engaging teeth, which are respectively in sliding contact with two of the first engaging teeth so as to permit rotation of the spool in a first direction, and which respectively engage the two first engaging teeth so as to prevent rotation of the spool in a second direction opposite to the first direction.

### BRIEF DESCRIPTION OF THE DRAWINGS

In drawings which illustrate embodiments of the invention,

Fig. is a perspective partly cutaway view of a conventional fly fishing reel;

FIG. 2 is a perspective partly cutaway view of another conventional fly fishing reel;

FIG. 3 is a perspective partly cutaway view of a first preferred embodiment of a fly fishing reel of this invention;

FIG. 4 is an exploded perspective view of a unidirectional controller of the first preferred embodiment;

FIG. 5 is a perspective partly cutaway view of a second preferred embodiment of a fly fishing reel of this invention; and

FIG. 6 is an exploded perspective view of a unidirectional controller of the second preferred embodiment.

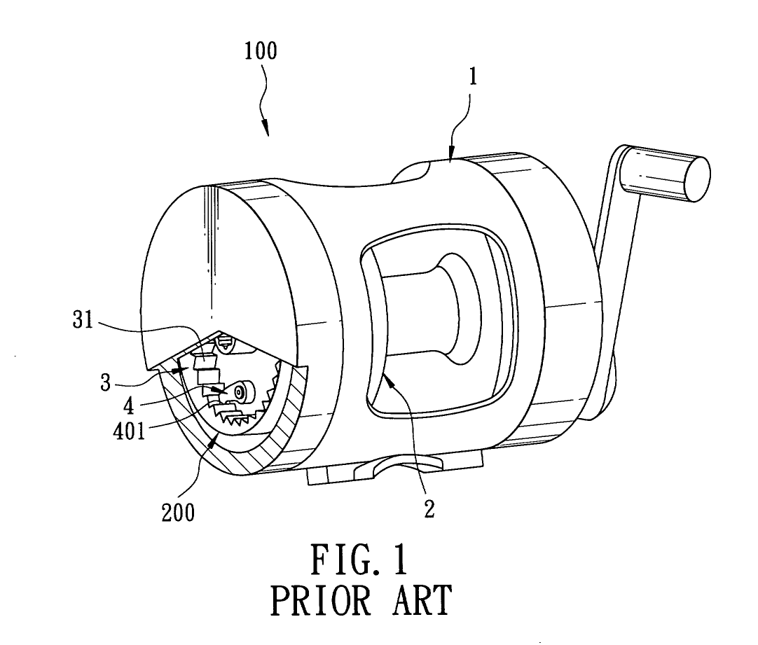

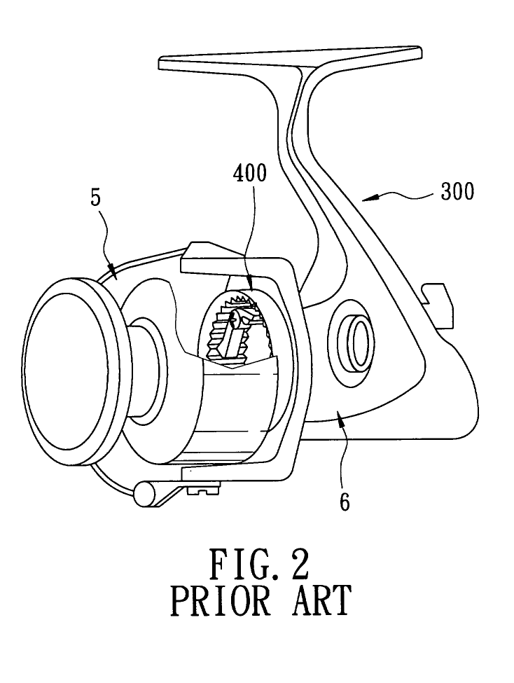

### DETAILED DESCRIPTION OF THE PREFERRED EMBODIMENTS

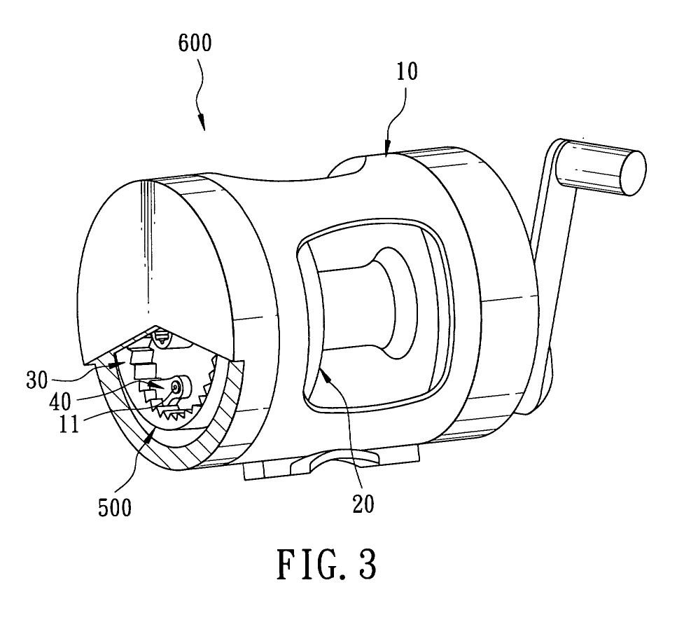

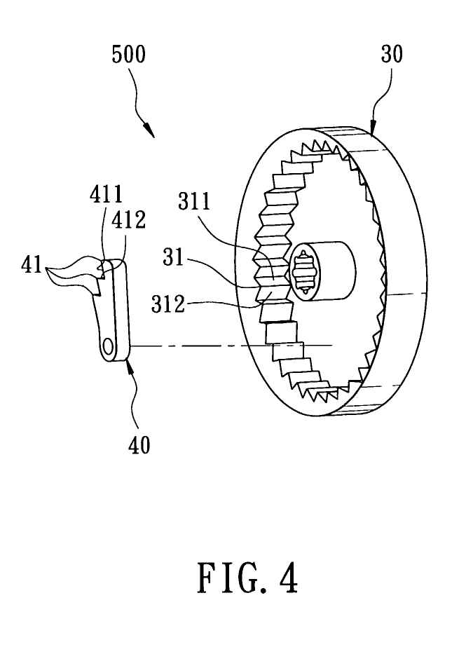

FIGS. 3 and 4 illustrate a first preferred embodiment of a fly fishing reel 600 of this invention.

The fly fishing reel 600 includes: a casing 10; a spool 20 mounted rotatably in the casing 10; and a unidirectional controller 500 including a ratchet wheel 30 mounted securely and co-axially on the spool 20, and a pawl 40 pivoted to the casing 10 via a pivot pin 11 and releasably engaging the ratchet wheel 20. The ratchet wheel 30 includes a plurality of angularly spaced apart first engaging teeth 31, each of which has a first sliding face 311 and a second engaging face 312 opposite to the first sliding face 311. The pawl 40 includes at least two angularly spaced apart second engaging teeth 41 (there are three second engaging teeth 41 in this preferred embodiment), which have second sliding faces 411 that are respectively in sliding contact with the first sliding faces 311 of two of the first engaging teeth 31 so as to permit rotation of the spool 20 in a first direction, and which have second engaging faces 412 that respectively engage the first engaging faces 312 of the two first engaging teeth 31 so as to prevent rotation of the spool 20 in a second direction opposite to the first direction. It is noted that the ratchet wheel 30 can be selectively secured to one of the casing 10 and the spool 20, and that the pawl 40 can be pivoted to the other one of the casing 10 and the spool 30.

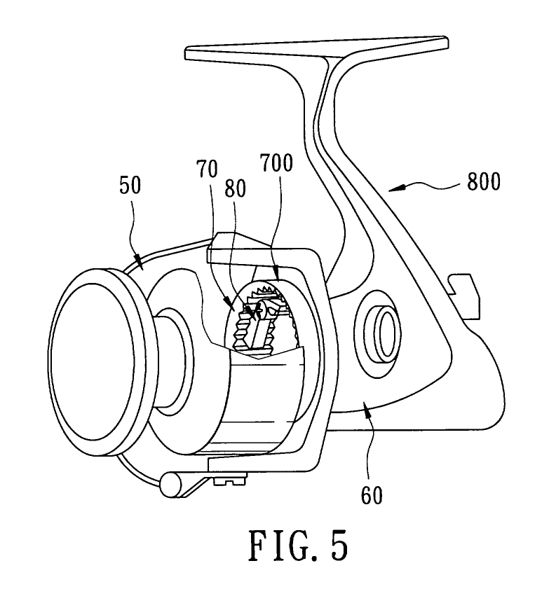

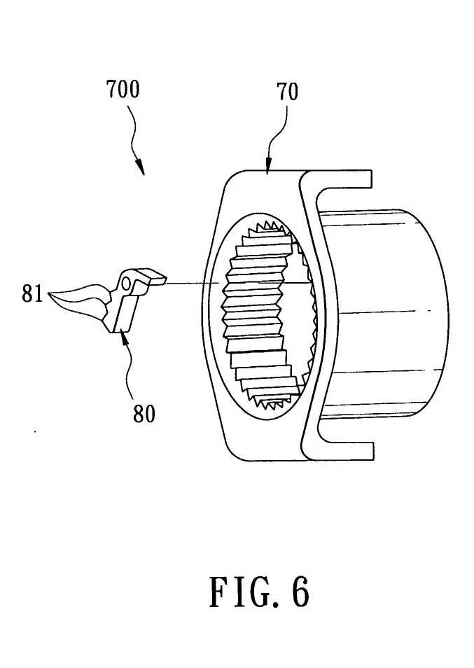

FIGS. 5 and 6 illustrate a second preferred embodiment of the fly fishing reel 800 of this invention. The fly fishing reel 800 includes a unidirectional controller 700 that is similar to that of the previous embodiment. Particularly, the controller 700 includes a ratchet wheel 70 and a pawl 80 with at least two engaging teeth 81. The fly fishing reel 800 is different from the previous embodiment in that a spool 50 is exposed from a casing 60 thereof.

Since the pawl (40, 80) includes more than one engaging tooth, the stress present at the pawl (40, 80) when a fish is caught can be distributed to the different teeth of the pawl (40, 80) so that the aforesaid drawback encountered in the prior art can be avoided.

With the invention thus explained, it is apparent that various modifications and variations can be made without departing from the spirit of the present invention. It is therefore intended that the invention be limited only as recited in the appended claims.

I claim:

1. A fly fishing reel comprising:
a casing;
a spool mounted rotatably in said casing; and
a unidirectional controller associated with said casing and said spool and including a ratchet wheel that is selectively secured to one of said casing and said spool, and a pawl that is pivoted to the other one of said casing and said spool and that releasably engages said ratchet wheel, said ratchet wheel including a plurality of angularly spaced apart first engaging teeth, said pawl including at least two angularly spaced apart second engaging teeth, which are respectively in sliding contact with two of said first engaging teeth so as to permit rotation of said spool in a first direction, and which respectively engage said two of said first engaging teeth so as to prevent rotation of said spool in a second direction opposite to said first direction.
